(19) United States
(12) Patent Application Publication
(10) Pub. No.: US 2015/0192913 A1
(43) Pub. Date: Jul. 9, 2015

(54) SYSTEMS AND METHODS FOR INDICATING AN ELECTRONIC DEVICE FAN CONDITION BASED ON CHANGE OF FAN ROTATION SPEED

(71) Applicant: TOSHIBA GLOBAL COMMERCE SOLUTIONS HOLDINGS CORPORATION, Tokyo (JP)

(72) Inventor: Edward J. Vitek, Raleigh, NC (US)

(73) Assignee: TOSHIBA GLOBAL COMMERCE SOLUTIONS HOLDINGS CORPORATION, Tokyo (JP)

(21) Appl. No.: 14/181,777

(22) Filed: Feb. 17, 2014

Related U.S. Application Data
(60) Provisional application No. 61/924,325, filed on Jan. 7, 2014.

(51) Int. Cl. G05B 15/02

(52) U.S. Cl. CPC G05B 15/02

(57) ABSTRACT

Systems and methods for indicating an electronic device fan condition based on change of fan rotation speed are disclosed. According to an aspect, a method includes determining a change of rotation speed of an electronic device fan. Further, the method includes determining whether the change of rotation speed meets a predetermined criterion. The method also includes indicating a fan condition in response to determining that the change of the rotation speed meets the predetermined criterion.

### CROSS REFERENCE TO RELATED APPLICATION

This application claims the benefit of U.S. Provisional Patent Application No. 61/924,325, filed Jan. 7, 2014 and titled SYSTEMS AND METHODS FOR INDICATING AN ELECTRONIC DEVICE FAN CONDITION BASED ON CHANGE OF FAN ROTATION SPEED, the content of which is hereby incorporated herein by reference in its entirety.

### TECHNICAL FIELD

The present invention relates to electronic device fans, and more specifically, to indication of an electronic device fan condition based on change of fan rotation speed.

### BACKGROUND

Electronic devices oftentimes produce unwanted heat that can result in either temporary or permanent failure of the electronic device. Many electronic devices utilize heat sinks, fans (or a combination of the two, or other cooling systems in order to cool the device and reduce the possibility of a premature failure. The cooling system or fan can be prone to failure, because they include mechanical components, such as bearings, that can freeze in place or fan blades that can collect so much dust and other debris that they can no longer turn. Further, even when the cooling system is electrically and mechanically operational, other issues can prevent cooling effectiveness, including blockage of air passages.

An example of such an electronic device is a computing device or a printer. The computing device may include components that produce so much heat that, without adequate cooling, the temperatures of these components would reach a point where either the device fails, or an internal mechanism shuts down the computing device until the temperature falls into a suitable operational range for the component.

In view of the foregoing, there is a need systems and methods for effectively indicating a condition of an electronic device fan.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for indicating an electronic device fan condition based on change of fan rotation speed. According to an aspect, a method includes determining a change of rotation speed of an electronic device fan. Further, the method includes determining whether the change of rotation speed meets a predetermined criterion. The method also includes indicating a fan condition in response to determining that the change of the rotation speed meets the predetermined criterion.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a system including an electronic device for indicating a fan condition based on change of fan rotation speed; and

FIG. 2 is a flow chart of an example method for indicating an electronic device fan condition based on change of fan rotation speed in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “electronic device” should be broadly construed. It can include any type of device including one or more electronic components. For example, an electronic device may be a computing device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer. Another example of an electronic device is a printer.

As referred to herein, the term “electronic device fan” or “fan” should be broadly construed. It can include any type of fan that is used for cooling components of an electronic device, such as a computing device or a printer. The fan may be positioned inside, or attached to, a case of a computing device or printer. The fan may be used for active cooling. The fan may draw cooler air into the case from the outside, expel warm air from inside, or move air across a heat sink to cool a particular component. Example usages of fans may be for cooling a central processing unit (CPU) heatsink, a heatsink of a graphics processing unit or memory on graphics cards, or a heatsink of a northbridge of a motherboard's chipset. Example fan types include, but are not limited to, an axial-flow type, a centrifugal type, and a crossflow type. An example fan includes, but is not limited to, a computing device fan provided by Advanced Micro Devices, Inc. of Sunnyvale, Calif.

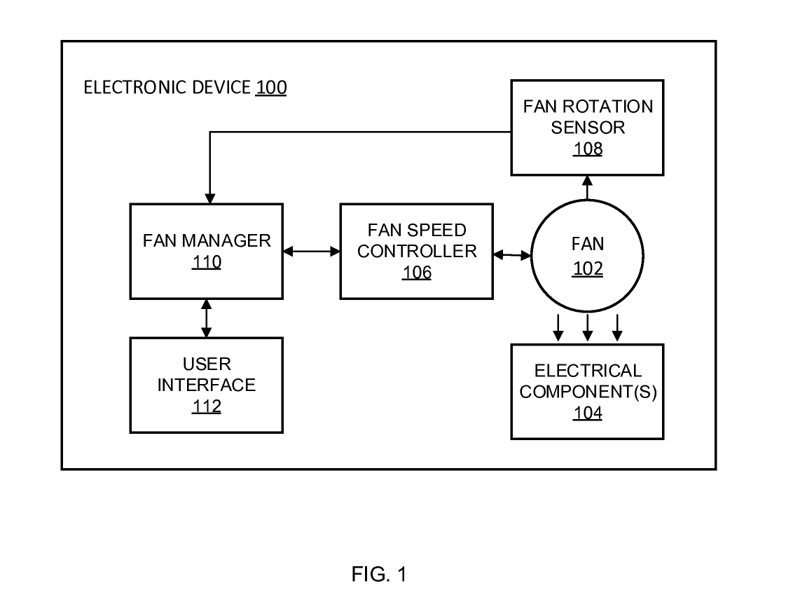

FIG. 1 illustrates a block diagram of a system including an electronic device 100 for indicating a fan condition based on change of fan rotation speed. Referring to FIG. 1, the electronic device 100 includes a fan 102 configured to cool one or more electrical components 104. A fan speed controller 106 may be configured to control an output of the fan 102. For example, the fan speed controller 106 may include one or more electrical and hardware components configured to output power to the fan 102 for controlling the fan speed. The fan speed controller 106 may control the fan 102 to operate while the electronic device 100 is active.

A fan rotation sensor 108 may be operationally connected to the fan 102 and configured to sense a rotation speed of the fan 102. The fan rotation sensor 108 may output an electrical signal that is indicative of the fan speed. A fan manager 110 may receive the electrical signal output by the fan rotation sensor 108. In accordance with embodiments of the present invention, the fan manager 110 may determine a condition of the fan 102 based on the electrical signal, and may control a user interface 112 to indicate the fan condition. An operator of the electronic device 100 may perceive the fan condition and interpret the indicated fan condition as indicating that the fan 102 is operating effectively, or that the fan 102 needs replacement, maintenance, or repair.

The fan manager 110 may be implemented with hardware, software, firmware, or combinations thereof. For example, the fan manager 110 may include one or more processors and memory configured to store instructions for implementation by the processor(s).

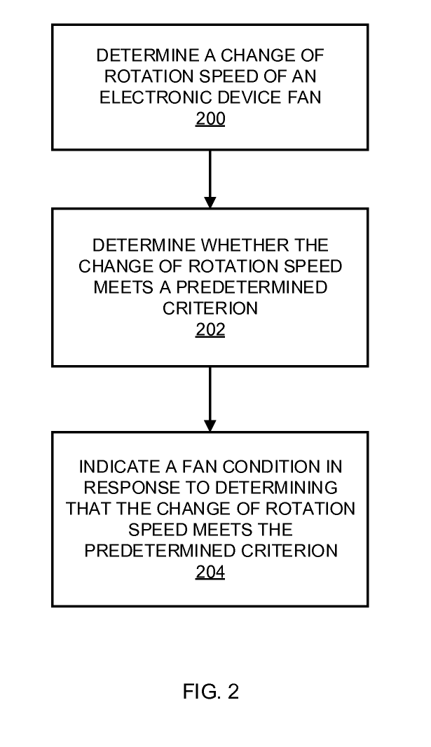

FIG. 2 illustrates a flow chart of an example method for indicating an electronic device fan condition based on change of fan rotation speed in accordance with embodiments of the present invention. In the examples provided herein, reference is made to the example electronic device 100 shown in FIG. 1, although it should be understood that the method may be implemented by any suitable electronic device having a fan.

Referring to FIG. 2, the method includes determining 200 a change of rotation speed of an electronic device fan. For example, the fan manager 110 may receive from the fan rotation sensor 108 the electrical signal indicative of the rotation speed of the fan 102. The fan manager 110 may receive the electrical signal over a period of time and determine the change of rotation speed over the period of time. As an example, the fan manager 110 may determine a rate of change of the speed of the fan 102. In another example, the fan manager 110 may determine a time required to change from a first rotation speed to a second rotation speed of the fan 102. In another example, the fan manager 110 may determine a time for the rotation speed to change from a first rotation speed to a second rotation speed when power to the fan 102 is either reduced or stopped. In another example, the fan manager 110 may determine a time for the rotation speed to change from a first rotation speed to a second rotation speed when power to the fan 102 is increased. The fan manager 110 can provide instructions to the fan speed controller 106 to reduce, stop, or increase the rotation speed of the fan 102 in this way in order to determine the fan speed response thereto.

The method of FIG. 2 includes determining 202 whether the change of rotation speed meets a predetermined criterion. Continuing the aforementioned example, the fan manager 110 may determine whether the change of rotation speed meets a predetermined criterion. For example, the fan manager 110 may determine whether the change of rotation speed is within a predetermined value. For example, the fan manager 110 may determine a time for the fan 102 to change from a known frequency of rotation (e.g., revolution per minute (RPM)) to another frequency of rotation when power to the fan motor is removed. For example, the change may be from 2000 rpm to 100 rpm, or another suitable set of rpms. In another example, the fan manager 110 may determine a time from a cold start (e.g., 0 RPM) to a desired rpm when power is applied to the fan 102. In another example, the fan manager 110 may determine a time from one rpm to another rpm when the speed is changed (e.g., changed the speed by changing the motor current). The predetermined criterion may be an acceptable value range for the change.

The method of FIG. 2 includes indicating 204 a fan condition in response to determining that the change of rotation speed meets the predetermined criterion. Continuing the aforementioned example, the fan manager 110 may control a display of the user interface 112 to display a fan condition of the fan 102 in response to determining that the change of the rotation speed meets the predetermined criterion. For example, the display may be controlled to display text and/or graphics to indicate the fan condition. In another example, the fan manager 110 may control a speaker of the user interface 112 to sound an alarm or provide a voice message to indicate the fan condition. In this way, an indicator of fan failure or fan operability, for example, may be provided.

In accordance with embodiments of the present invention, a prediction of failure of a fan may be presented in response to determining that the change of the rotation speed meets the predetermined criterion. For example, the fan manager 110 may predict failure of the fan 102 based on the change of rotation speed of the fan 102. As an example, the failure may be predicted if the change of rotation speed is a predetermined value. The prediction may include, for example, an estimate of time to failure for the fan 102. The fan manager 110 may determine the time estimate based on the change of the rotation speed. The prediction may be indicative of a warning of fan failure or of a need for maintenance.

In accordance with embodiments of the present invention, fan condition may also be determined based on one or more other factors. For example, the fan manager 110 may determine the fan condition based on the change of rotation speed of the fan 102 in addition to one or more of air temperature, fan current, fan voltage, and the like. These factors may be used by the fan manager 110 for predicting fan failure, particularly time to failure for the fan 102.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
determining a change of rotation speed of an electronic device fan;
determining whether the change of rotation speed meets a predetermined criterion; and
in response to determining that the change of the rotation speed meets the predetermined criterion, indicating a fan condition.

2. The method of claim 1, wherein determining a change of a rotation speed comprises determining a rate of change of the speed of the electronic device fan.

3. The method of claim 1, wherein determining a change of a rotation speed comprises determining a time required to change from a first rotation speed to a second rotation speed of the electronic device fan.

4. The method of claim 1, wherein determining a change of a rotation speed comprises determining a time for the rotation speed to change from a first rotation speed to a second rotation speed when power to the electronic device fan is one or reduced and stopped.

5. The method of claim 1, wherein determining a change of a rotation speed comprises determining a time for the rotation speed to change from a first rotation speed to a second rotation speed when power to the electronic device fan is increased.

6. The method of claim 1, wherein determining a change of a rotation speed comprises determining a time for the rotation speed to change from a first rotation speed to a second rotation speed when the rotation speed is controllably changed.

7. The method of claim 1, wherein determining whether the change of rotation speed meets a predetermined criterion comprises determining whether the change of rotation speed is within a predetermined value, and
wherein indicating a fan condition comprises presenting an indicator of fan failure in response to determining that the change of the rotation speed is within the predetermined value.

8. The method of claim 1, further comprising presenting a prediction of failure in response to determining that the change of the rotation speed meets the predetermined criterion.

9. The method of claim 8, wherein presenting a prediction of failure comprises presenting an estimate of time to failure for the electronic device fan.

10. The method of claim 1, further comprising:
receiving one of air temperature, fan current, and fan voltage; and
determining the fan condition based on the one of air temperature, fan current, and fan voltage.

11. The method of claim 1, wherein indicating a fan condition comprises one of displaying an indicator of the fan condition and sounding an alert.

12. A system comprising:
an electronic device fan; and
a fan manager comprising a processor and memory and configured to:
determine a change of rotation speed of the electronic device fan;
determine whether the change of rotation speed meets a predetermined criterion; and
indicate a fan condition in response to determining that the change of the rotation speed meets the predetermined criterion.

13. The system of claim 12, wherein the fan manager is configured to determine a rate of change of the speed of the electronic device fan.

14. The system of claim 12, wherein the fan manager is configured to determine a time required to change from a first rotation speed to a second rotation speed of the electronic device fan.

15. The system of claim 12, wherein the fan manager is configured to determine a time for the rotation speed to change from a first rotation speed to a second rotation speed when power to the electronic device fan is one or reduced and stopped.

16. The system of claim 12, wherein the fan manager is configured to determine a time for the rotation speed to change from a first rotation speed to a second rotation speed when power to the electronic device fan is increased.

17. The system of claim 12, wherein the fan manager is configured to determine a time for the rotation speed to change from a first rotation speed to a second rotation speed when the rotation speed is controllably changed.

18. The system of claim 12, wherein the fan manager is configured to:
determine whether the change of rotation speed is within a predetermined value; and
present an indicator of fan failure in response to determining that the change of the rotation speed is within the predetermined value.

19. The system of claim 12, wherein the fan manager is configured to present a prediction of failure in response to determining that the change of the rotation speed meets the predetermined criterion.

20. The system of claim 19, wherein the fan manager is configured to presenting an estimate of time to failure for the electronic device fan.

21. The system of claim 12, wherein the fan manager is configured to:
receive one of air temperature, fan current, and fan voltage; and
determine the fan condition based on the one of air temperature, fan current, and fan voltage.

22. The system of claim 12, further comprising a user interface configured to one of display an indicator of the fan condition and sound an alert.

23. A computer program product for indicating an electronic device fan condition, the computer program product comprising a computer readable storage medium having program instructions embodied therewith, the program instructions readable by a computing device to cause the computing device to:
determine, by the computing device, a change of rotation speed of the electronic device fan;
determine, by the computing device, whether the change of rotation speed meets a predetermined criterion; and
indicate, by the computing device, a fan condition in response to determining that the change of the rotation speed meets the predetermined criterion.
